(19) United States
(12) Patent Application Publication
(10) Pub. No.: US 2004/0063424 A1
(43) Pub. Date: Apr. 1, 2004

(54) System and method for preventing real-time and near real-time fraud in voice and data communications

(76) Inventors: Eli J. Silberstein, Lakewood, NJ (US); Dave Trop, Lakewood, NJ (US); Isai Shenker, Westfield, NJ (US); James Joseph Brockman, Perrineville, NJ (US)

Correspondence Address: Paul D. Greeley, Esq., Ohlandt, Greeley, Ruggiero & Perle, L.L.P., 10th Floor, One Landmark Square, Stamford, CT, 06901-2682, US

(21) Appl. No.: 10/259,170

(22) Filed: Sep. 27, 2002

(51) Int. Cl. H04M 1/66; H04M 1/68; H04M 3/16

(52) U.S. Cl. 455/410; 455/411

(57) ABSTRACT

A system and method for detecting and preventing fraudulent usage or activity with a mobile and/or landline telephone network. The system determines whether the call is authorized by comparing customer specific data and call data to a set of usage rules. A call data report is generated for completed calls and analyzed to determine fraud patterns, wherein the usage rules are updated based on the identified fraud patterns.

### BACKGROUND OF THE INVENTION

1. Field of the Invention

The present invention generally relates to a system and method for detecting, preventing and monitoring possible fraudulent usage or activity within a mobile and/or land line telephone network for either voice or data communications that require a connection through the telephone systems. A system and method is provided for ensuring voice call or data connection delivery to the fraud control platform from any originating telephone location, for ensuring authorized usage by validating the calling party and allowing the calling party access to the telephone network; and for monitoring, detecting and responding to possible fraudulent usage or activity.

2. Discussion of the Background Art

Currently, most wireless providers offer limited international calling capabilities with cumbersome restrictions, but are hesitant to broaden these services to make them more readily available to subscribers because of the perception of higher risk of fraud on international calls, and their concerns related to managing and preventing fraud and bad debt, and customer retention issues due to cumbersome ancillary support services. Many of these concerns stem from the inherent nature of the wireless provider's environment that is sometimes comprised of multiple wireless providers being incorporated into a single entity before streamlining all of the different provisioning, billing, and other wireless provider systems from each of the different wireless providers. Additionally, the subscriber requirement to be able to roam, to be able to make and receive calls outside of the subscriber's home area, or even for that matter outside of the subscriber's wireless provider's coverage network, requiring the use of another wireless provider's network.

Within the telephone network, there are basically two general types of procedures capable of monitoring and preventing fraudulent behavior. One general type is to use subscriber or customer based information and the other general type is to use call based or usage information. The large bulk of wireless providers use the subscriber or customer based information type of procedures simply because the information is more readily available. Call or usage based information is sometimes not available at all if this is a new subscriber entirely, and even if the subscriber has some past historical information, this kind of information is not readily shared among or between the wireless providers.

Fraudulent wireless telephone calls resulting from stolen handsets or cloning cost the cellular telephone industry losses of hundreds of millions of dollars a year. As the cellular telephone industry continues to rapidly expand, the fraud losses continue to grow. Some of these losses are attributed to roaming fraud which results from cloned handsets used outside the customer's home region.

Other losses are based on customers who do not pay for servicing. For example, sometimes the customer will open a cellular account with no credit or a stolen credit history with no intention of paying the bill. Other examples include opening an account with a stolen identification. Regardless of the fraudulent method used, the result is large unpaid telephone bills which in turn cause substantial business losses on wireless companies balance sheets. This is also due in a large part, to the way the wireless providers offer their services. Since many wireless providers are eager to show large subscriber bases, they are willing to offer their domestic services with looser credit approval procedures than would be thought to be appropriate for such services. Additionally, once a wireless subscriber has been approved, there are few if any, subsequent credit procedures to notify the wireless provider about changes in the subscriber's profile.

In the landline environment, however, many of these losses are avoided simply by the fact that telephone services delivered to a specific address is usually linked to a specific person, making it easier to track fraudulent usage. Additionally, landline telephone services are not mandatory services that must be provided by the landline telephone providers, and therefore can be forfeited through a lack of payment of outstanding charges, also resulting in negative reporting to the credit agencies. For these reasons, the subscriber is more careful in their telephone usage and less prone to allow fraudulent use.

What is needed is a fraud control system and method that can identify fraud patterns and prevent fraudulent telephone activity. In view of the foregoing, it would be highly desirable to provide a comprehensive system and method addressing the above mentioned concerns, using a combination of both call or usage based information and subscriber information, to identify in real-time or near-real time, the possible fraudulent behaviors, and enabling the provider to take immediate action in authorizing international telephone calls for an authorized customer only and not for a fraud perpetrator, thus preventing fraudulent telephone activity.

### SUMMARY OF THE INVENTION

A system and method for providing a fraud control system for preventing telephone call fraud originating from wireless telephones including a fraud analysis system for identifying caller fraud patterns; and using the identified fraud patterns to update a set of usage rules used to approve calls in the system.

A fraud control platform for preventing fraud in international telephone calls received from a wireless carrier including a call processing system that compares customer data to a set of usage rules to determine whether the international call is approved.

The present invention also provides a data management system for a fraud control system for fraud prevention in a long distance telephone call platform including a call data report database, billing server, and a reconciliation data processor connected to the database.

A system is also provided for detecting fraud in a long distance telephone call fraud control system including a call processing system for analyzing call data based on a set of usage rules and a fraud analysis system for analyzing the results of the application of the usage rules to determine fraud patterns.

A method of preventing fraudulent long distance telephone calls by determining whether a call subscriber meets a fraud platform usage requirements based on a rules based system included in the fraud platform.

A method for terminating international telephone calls on a mobile network in real time by comparing the real time updated call data to usage thresholds and terminating the call if the usage threshold is exceeded.

A method of providing secure usage within an international telephone call fraud control platform by interacting with the caller to obtain additional security information and terminating the call if the security information is incorrect.

The present invention also provides a method of analyzing international calls to determine if fraud patterns exist by generating a call data report and analyzing the call data report to determine if a fraud pattern exists based on comparisons to fraud thresholds.

A method of blocking a call from accessing a fraud control platform by denying access to a fraud control platform based on specific subscriber information contained in the platform data base.

These and other advantages will be apparent from the following detailed description of the invention, drawings, and claims.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a functional block diagram illustrating the fraud control system according to one embodiment of the present invention;

FIG. 2 illustrates an example of customer data according to one embodiment of the present invention;

FIG. 3 illustrates an example of customer profile data according to one embodiment of the present invention; and

FIG. 4 illustrates one example of the call threshold flags of the fraud analysis systems of FIG. 1.

### DETAILED DESCRIPTION OF THE PREFERRED EMBODIMENTS

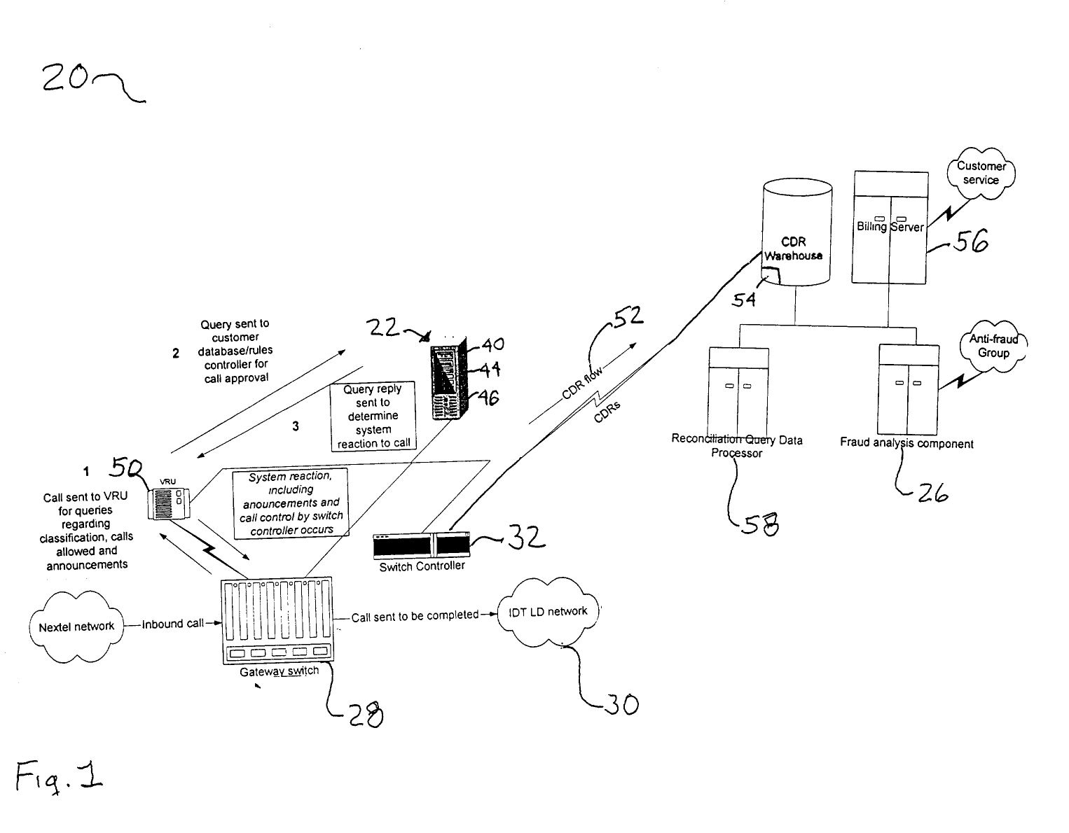

Referring now to FIG. 1, fraud control system or platform 20 according to one embodiment of the present invention, includes call processing system 22 and data management system 24. Data management system 24 may include fraud analysis system 26 or the fraud analysis system may be a separate system. Voice traffic arriving from the wireless carrier is received by system 20 via gateway switch 28, and after system approval, the gateway switch connects the customer or subscriber to telephone carrier network 30. Call data is then generated and sent via switch connector 32 to data management system 24 for billing and fraud analysis.

Call processing system 22 processes each call to determine whether the customer or subscriber meets a predetermined approval criteria required by system 20. Call processing system 22 includes customer database 34. Customer database 34 includes customer data 36 that is used to develop customer profile 38. Customer profile 38 may also include predetermined usage thresholds 42 determined by the customer. The call processing system also includes rate data base or lookup table 40 to determine call costs. Usage rule controller 44 compares customer profile 38 and rate data from lookup table 40 to a set of usage rules 46. Usage rules 46 may include system level usage thresholds 48. The call is connected if the customer meets usage rules 46. If addition information is required from a customer, such as security information, a VRU 50 may be programmed to make specific announcements to the customer requesting the additional information.

During the call, call processing system 22 monitors the call and continually updates customer database 34. After the call is completed, call data record or call detail record 52 is generated and sent via switch controller 32 to data management system 24. Call data record (CDR) 52 may be stored in a warehouse or storage server 54 of data management system 24. Data management system 24 may also include billing server 56 and billing reconciliation server 58. Call data record 52 is received by CDR warehouse system 42 within call data system 24. Each call data record 52 may then be evaluated by fraud analysis system 26 to determine fraud patterns. Fraud analysis system 26 updates usage rules 46 based on the identified fraud patterns.

Fraud control system 26 requires that call process system 22, data management system 24 and fraud analysis system 26, to continually exchange information to prevent fraudulent activity. System 20 requires customer database 34 and usage rules 36 to be continually updated in order for minimize fraudulent activity.

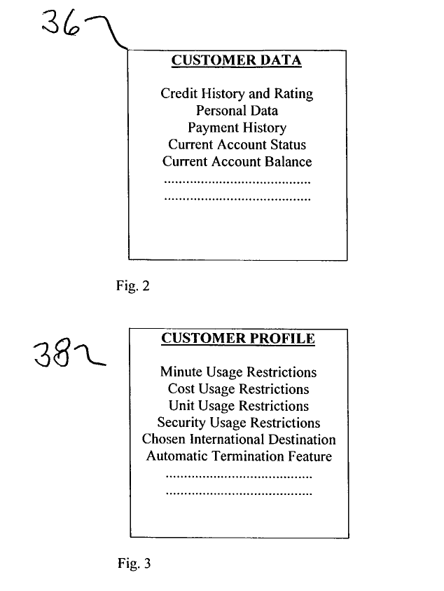

Customer database 34 includes information received from the wireless carrier about the customer. Customer database 34 includes specific customer data 36, such as customer payment history and customer personal data, or other information as shown in FIG. 2. Customer data 34 may be utilized to categorize the customers in rating types or groups for processing. For example, one method of categorizing customers includes three categories for customers with very limited customer personal and credit data; specific group customer personal and credit data; and specific individual customer personal and credit data. Once a subscriber is categorized, customer profile 38 is created. Customer profile 38 determines access requirements for a customer, and establishes maximum usage criteria or usage thresholds 42 for the customer.

Customer profile 38 is created to include information that may be compared to usage rules 46. For example, profile 38 may include customer allowable usage thresholds 42, security requirements, or other pertinent data, as shown for example in FIG. 3. In addition, the customer can optionally place restrictions on their personal account. For example, the customer may want restrictions based on minute usage, cost, units, specific customer choices (access to certain countries only), or additional security features. The options chosen by the customer will be entered into customer profile 38 and stored with user usage thresholds 42.

The usage rules 46 are developed to prevent fraudulent telephone calls, including international telephone calls, from being completed. The usage rules 46 are developed to analyze a customer's access to the system 20 based on customer data 36 and call rates, to determine whether usage thresholds 42 or system thresholds 48 are broken. For example, the usage rules 46 may include comparisons to customer identified usage thresholds 42. The application of the usage rules 46 to the customer usage threshold 42 prevents the customer from making additional calls, once the caller usage threshold 42 is reached. System thresholds 48 may also be implemented toward specific groups of callers based on the customer database 34. The usage rules 46 may also be applied to system thresholds 42 based on the individual call or cumulative length of a call. For example, a system usage threshold 42 may be based on a number of calls within a period of time, such as five calls per day or forty calls per week, for a customer.

The usage rule controller 44 implements the usage rules 46 based on the customer data 36, customer profile 38, and the call rate data. The usage rules 44 are developed to provide great flexibility in order to prevent fraudulent activity. The usage rules 46 may include a cumulative usage threshold, that allows the system 20 provider to allocate specific groups of users or individual user a specific allotment for a time period. The allotment can also be tailored to be to a specific country based on the customer's profile. Once the allotment of time is exhausted, additional calls will not be allowed.

In addition, the usage rules controller 44 can be optionally programmed to terminate a call when usage thresholds 42, 48 are reached, even when the call is in process. For example, if this termination option is programmed, the call will be terminated in real time when the call duration or call cost has reached a predetermined usage threshold. The caller may also hear an announcement from VRU 50.

The usage rules 46 may also include the option of blocking subscribers from accessing all international destinations. The caller may hear a special message, that the caller is attempting to reach a restricted destination.

In addition, the usage rules 46 may enable the fraud control system 20 to block a call already received in the system 20 if the subscriber's account is under fraud investigation, phone has been reported lost or stolen, account is delinquent, the account is closed. A blocked call may optionally be transferred to the wireless carrier's customer service.

The usage rules 46 are updated based on information received from the fraud analysis system 26. The fraud analysis system 26 analyzes call data reports or records 52 generated by the call processing system 22. The call processing system 22 sends the call data record 52 via the switch controller 40 to the data management system 24. The call data reports or call detail records 52 may be accessed by the fraud analysis system 26.

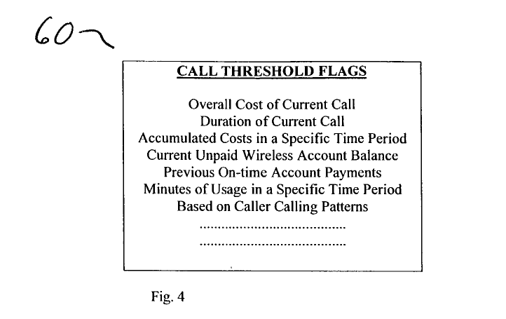

The fraud analysis system 26 identifies and researches fraud patterns based on the call data records 52. The call data reports 52 are analyzed by measuring and comparing the existing system processes, call patterns and other statistical data to identify fraud patterns. The call data reports 52 are analyzed and scored according to scoring alerts or call threshold flags 42, 48 for an individual customer. The individual customer call data reports 52 are also compiled and compared to threshold flags 42, 48 to determine if new fraud patterns exist. For example, call threshold flags 42, 48 may include suitable call data related and customer related information necessary for usage rule development. Call threshold flags 42, 48 may include the overall cost of the current call, the customer's current unpaid account balance or other information, for example, as identified in FIG. 4.

Based on the identified fraud patterns, the usage rules 46 may be updated by being defined, created, tested and programmed in the fraud analysis system 26. The updated usage rules 46 are then transferred and programmed into the call processing system 22. The updated usage rules 46 may include updating of the system based thresholds, automatic notifications and/or alarms.

The fraud analysis system 26 analyzes customer accounts to determine if the fraudulent behavior is occurring. Based on the analysis of the customer database 36, the system alerts the user by a notification or cancellation of the account. Summary analyses are also completed on all the call data records 52 to determine system wide fraud patterns. Both individual and system wide fraud patterns can be used to update the usage rules 46.

The fraud analysis system 26 also defines customer service and investigative departments' scripts and responses, including procedures to determine fraudulent behavior, and also defines the reports and notifications for system usage reviews, and financial reviews and projections. Notifications and alarms may be sent to the customer and/or the wireless carrier.

The data management system 24 also forwards the call data reports 52 to the billing server 56. The billing server 56 prepares billing records based contractual agreements with the wireless carrier. The data management system 24 also includes a billing reconciliation system 58 for reconciliation of bills. The data management system 24 also forwards billing data and reconciliation data to the wireless carriers according to a predetermined schedule.

Referring again to FIG. 1, the fraud control system 20 interacts with the wireless carrier to prevent international call fraud. A customer may activate their wireless telephone and the wireless carrier authenticates and authorizes the customer to use the wireless carrier network. The wireless carrier may then validate the customer's account, rates, services and restrictions, and download this information to a mobile switching center (MSC) if applicable.

The wireless customer then dials an international long distance telephone number and is routed to the fraud control system 20. The caller can be connected to the system 20 by a variety of methods, include a standard carrier to carrier trunking scenario. The fraud control system 20 provides secure connectivity by ensuring call delivery to the system from any originating telephone system. The secure connectivity may include either manual or automatic routing of the telephone calls within the telephone networks to the fraud control system 20. The specific routing methods can be based upon a multiple set of choices determined by either the telephone service carrier or the caller.

In some cases the customer's standard carrier-to-carrier connectivity is not available. Other alternative call connectivity options exist, such as, using a global system for mobile communications (GSM) based service utilizing a subscriber identification module (SIM) card to automatically redirect calls to the system 20; using of an MSC short code; dialing a direct toll free telephone number; using a hot field to overdial a new telephone number; redefining the SS7 routing and messaging within the wireless carriers and their affiliate networks; using a carrier identification code (CIC) code; and using a virtual private network (VPN).

Once the call is received by the fraud control system 20 via gateway switch 28, call processing system 22 may provide a secure usage to the system 20 by ensuring authorized usage. The usage is authorized by validating the calling party, and allowing the calling party access to the system. The validation occurs by requiring every caller to have a unique access code in order to make telephone calls. The unique access code is a combination of the telephone number the caller is using to make the call, and another set of numbers determined by either the telephone service carrier or the caller. For example, the other set of numbers could be a customer's personal identification number (PIN).

After the incoming call is received, the call processing system can determine the number of the telephone used to make the call. Call processing system 22 may then request additional information from the caller by activating the VRU 50 to provide preprogrammed announcements to the caller. The announcements may request that the customer enter the customer's PIN. Based on the telephone number on the handset and the entered PIN number, the call processing system will determine whether the customer may gain access to the fraud control system 20. If the PIN was entered correctly, and the customer originating number is correct, the call processing system will authorize access to the fraud control system. If the PIN number was not correctly entered, or fraud concerns were identified associated with the telephone number on the handset, the customer may not be granted access to the fraud control system, and the call would be terminated. The customer may hear an announcement requesting that the customer please make a call to customer service.

VRU 50 can also be programmed to make other announcements to the caller. For example, the VRU 50 can provide an announcement that provides subscriber threshold information such as, minutes under the subscriber's plan are exhausted, or the minutes under the subscriber's plan are exhausted for a specific destination. The VRU 50 may also provide an announcement requesting the caller to contact the system administrator, such as requesting that the caller contact customer assistance. The VRU 50 has almost unlimited voice announcement capability, and can be customized based on information required by the usage rules 46.

The call processing system 22 then receives the destination telephone number along with a customer call line identity (CLI). The CLI can be a personal identification number (PIN) number or can be transferred automatically from the hand set. The call processing system 22 accesses the customer profile 38 in the customer database 34 based on the customer's CLI. The customer's CLI is used to uniquely identify the subscriber and access their customer profile 38 for call completion and real time fraud monitoring. The customer profile 38 identifies any customer restrictions to the call processing system 22, including customer identified usage thresholds 42. The destination number is also used for fraud control and call completion. Based on the destination number, the call processing center 22 determines the rates and regions for the call from a rate database or look-up table 40, included in the customer database 34.

Customer profile 38 and destination number look-up data rates are then forwarded to usage rules controller 44. Usage rules controller 44 completes an analysis of the customer profile 38 and the call rates, compared to usage rules 46 to determine whether the call should be connected. If the customer is above usage thresholds 42, 48 the call is disconnected and the caller may hear an announcement from the VRU 50. If the caller is below usage thresholds 42, 48 the caller is connected via the gateway switch 28 to the telephone carrier network 30.

After being connected, the call processing system 22 will monitor the call and forward updated call data (e.g., call cost, length, etc.) to the customer database 34, and the real time customer data 36, and call data (e.g., cost and call length) will be again compared to the usage rules 44 by the usage rules controller 44. The continual application of the usage rules 46 to the customer data 36 allows the call processing system 22 to continually check to determine if the customer usage thresholds 42 or system usage thresholds 48 have been reached. Optionally, a call can be terminated in real time if usage thresholds 42, 48 are surpassed.

Once the call is completed, call processing system 22 forwards a call data report 52 to data management system 24 for billing and fraud analysis. Fraud analysis system 26 monitors, detects and responds to fraudulent usage or activity. Fraud analysis system 26 uses real-time call-based data thresholds, and rules, resulting in either automatic or manual responses to the fraudulent activity.

Fraud analysis system 26 analyzes the call data records 52 to determine fraud patterns. Fraud analysis system 26 may include programming (such as, fraud specific usage rules) to determine negative as well as positive data, velocity (not just static thresholds), profiles, scoring and fuzzy logic. Fraud analysis system 26 modifies call processing system usage rules 46 to counter new fraud techniques used by perpetrators, to also develop new anti-fraud techniques, and evaluates current anti-fraud techniques for effectiveness. Updated usage rules 46 are then forwarded to call processing system 22 and updated in usage rules controller 44. The result is a fraud control system 20 that can rapidly respond to caller fraud patterns to decrease fraudulent costs associated with international long distance calls.

While we have shown and described several embodiments in accordance with our invention, it is to be clearly understood that the same are susceptible to numerous changes apparent to one skilled in the art. Therefore, we do not wish to be limited to the details shown and described but intend to show all changes and modifications which come within the scope of the appended claims.

What is claimed is:

1. A fraud control system for preventing telephone fraud comprising:
a data processor capable of comparing call data generated from a particular call to at least one usage rule; and
means for terminating said call if said usage rule is not met.

2. The fraud control system of claim 1, wherein said data processor compares said call data simultaneously with said call being conducted.

3. The fraud control system of claim 1, further comprising a data management system for storing and/or compiling call data generated from said call.

4. The fraud control system of claim 3, further comprises a means for analyzing said stored and/or compiled call data, thereby identifying fraud patterns and modifying said at least one usage rule based on the identified fraud patterns.

5. The fraud control system of claim 1, wherein said usage rule is at least one selected from the group consisting of: (a) a wireless telephone is used to make said call, (b) said call is made to a country other than the country domicile to said caller, (c) said call is for a time limit greater than a predetermined time limit, and (d) the cost of said call exceeds a predetermined limit.

6. A fraud prevention system comprising:
a data processor for comparing call data to a predetermined limit; and
means for terminating said call when a predetermined limit is exceeded.

7. The fraud prevention system of claim 6, wherein said predetermined limit is at least one selected from the group consisting of: length of said call; and cost of said call.

8. The fraud prevention system of claim 6, further comprising: a means for storing and/or compiling said call data.

9. The fraud prevention system of claim 8, wherein said predetermined limit is updated based on said stored and/or compiled call data.

10. A method of preventing telephone call fraud comprising:
generating real time call data during a telephone call;
comparing said call data to at least one usage rule; and
terminating said call if said usage rule is not met.

11. The method of claim 10, wherein said usage rule is at least one selected from the group consisting of: (a) a wireless telephone is used to make said call, (b) said call is made to a country other than the country domicile to said caller, (c) said call is for a time limit greater than a predetermined time limit, and (d) the cost of said call exceeds a predetermined limit.

12. A method of preventing wireless telephone call fraud comprising:
identifying an incoming wireless telephone call subscriber;
determining the call per minute cost;
comparing the cumulative call cost each minute during the duration of said call against a predetermined limit; and
terminating said call if the actual cost exceeds said predetermined limit.
